(19) United States
(12) Patent Application Publication
(10) Pub. No.: US 2007/0218750 A1
(43) Pub. Date: Sep. 20, 2007

(54) Snap-off screw with recessed breakoff area

(75) Inventors: Ernie Corrao, Bethel, CT (US); Rebecca Hawkins Wahl, Escondido, CA (US); Alan G. Taylor, Memphis, TN (US)

Correspondence Address: THE LAW OFFICE OF STEVEN G ROEDER, 5560 CHELSEA AVE, LA JOLLA, CA, 92037, US

(73) Assignee: Nexa Orthopedics, Inc.

(21) Appl. No.: 11/711,954

(22) Filed: Feb. 27, 2007

Related U.S. Application Data
(60) Provisional application No. 60/783,769, filed on Mar. 17, 2006.

(51) Int. Cl. H01R 4/24

(52) U.S. Cl. 439/404

(57) ABSTRACT

A snap-off screw (10) for insertion into one or more two bone regions (12A) (12B) includes a screw body (14) having a screw region (16) and a driver region (18). Upon insertion of the screw region (16), the driver region (18) is designed to be decoupled from the screw region (16). The screw region (16) includes a screw distal end (224), an opposed screw proximal end (226), a threaded area (228), and a head area (232) positioned at the screw proximal end (226). The driver region (18) includes a driver attachment end (238) and an opposed driver distal end (240). The driver attachment end (238) is coupled to the screw region (16) between the screw distal end (224) and the screw proximal end (226). With this design, when the driver region (18) is decoupled from the screw region (16), a screw break surface (460) is positioned below a portion of the head area (232) of the screw region (16). As a result thereof, the screw break surface (460) does not provide an area of irritation for soft tissue around the inserted snap-off screw (10).

### RELATED APPLICATION

This application claims priority on U.S. Provisional Patent Application Ser. No. 60/783,769 filed on Mar. 17, 2006 and entitled “SNAP-OFF SCREW WITH RECESSED BREAKOFF AREA”. The contents of U.S. Provisional Application Ser. No. 60/783,769 are incorporated herein by reference.

### BACKGROUND

It is often necessary to fuse two bone regions to repair a fracture or to fuse a joint. On type of device used to fuse two bone regions is a snap-off screw that includes a screw region and a driver region. With this device, the screw region is threaded into the bone regions and pulls the bone regions together. Further, the driver region is engaged by a screw driver or a drill. With this design, rotation of the driver region results in rotation of the screw region and insertion of the screw region. Subsequently, after insertion of the screw region, the driver region can be broken away from the screw region.

### SUMMARY

The present invention is directed toward a snap-off screw for screwing into a bone region. The snap-off screw includes a screw body having a screw region and a driver region. The screw region includes a screw distal end, an opposed screw proximal end, a threaded area, and a head area positioned at the screw proximal end. The driver region includes a driver attachment end and an opposed driver distal end. The driver attachment end is coupled to the screw region between the screw distal end and the screw proximal end.

Upon insertion of the screw region, the driver region is designed to be decoupled from the screw region. In certain embodiments, the snap-off screw is designed to break below the head area so that the screw region does not provide an area of irritation for soft tissue around the inserted snap-off screw. As a result thereof, the likelihood of success of the procedure is enhanced.

In one embodiment, the screw region includes a recessed area and the driver attachment end is positioned within the recessed area. As a result thereof, a breakoff area of the screw body is positioned within the recessed area below the head area. It should be noted that the breakoff area is the area of the screw body in which the driver region becomes decoupled from the screw region.

The present invention is also directed a method for engaging a bone region. The method includes the steps of threading a screw region of a snap-off screw into a bone region, and decoupling a driver region of the snap-off screw from the screw region. The screw region includes a screw distal end, an opposed screw proximal end, a threaded area, and a head area positioned at the screw proximal end. The snap-off screw is designed so that a screw break surface of the screw region is recessed below the head area. Further, the screw break surface is encircled by the head area.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a simplified side illustration of a pair of bone regions, in cut-away, that are fused together with a portion of a snap-off screw having features of the present invention;

FIG. 2A is a side view of a first embodiment of a snap-off screw having features of the present invention;

FIG. 2B is an end view of the snap-off screw of FIG. 2A;

FIG. 3A is a cut-away view taken on line 3A-3A of FIG. 2B;

FIG. 3B is an enlarged detail view taken from FIG. 3A;

FIG. 3C is an enlarged detail view taken from FIG. 3A; and

FIG. 4 is a cut-away view of a portion of the snap-off screw in a broken configuration.

### DESCRIPTION

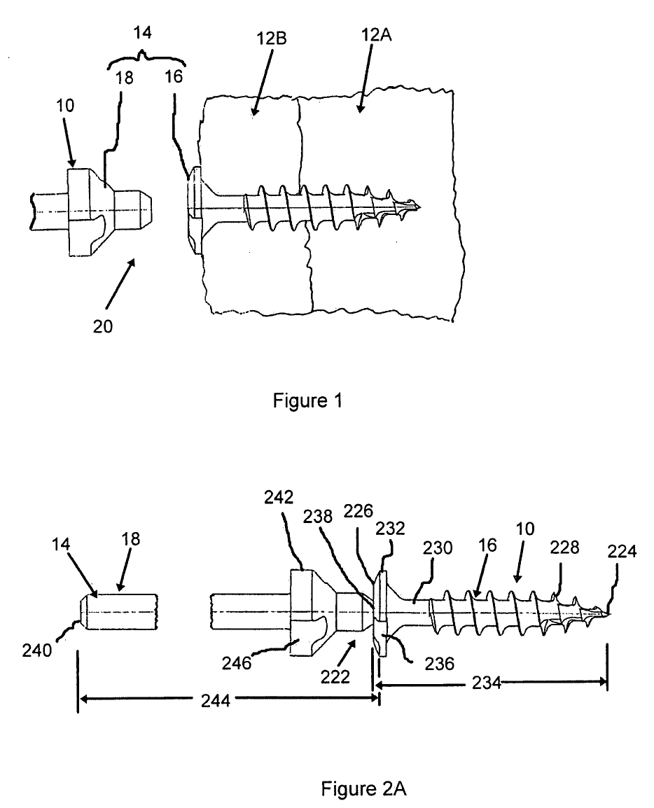

FIG. 1 is a simplified side illustration a portion of a snap-off screw 10 having features of the present invention, a first bone region 12A and a second bone region 12B of a human. In this embodiment, the snap-off screw 10 is used to urge the bone regions 12A, 12B together so that the bone regions 12A, 12B are fused together. The type and location of the bone regions 12A, 12B urged together can vary. For example, the snap-off screw 10 can be used to fuse a fracture of a human bone, to immobilize and fuse a human joint, or to fuse together adjacent bones. Alternatively, for example, one or more snap-off screws 10 can be used to secure a plate (not shown) or other device to one or more bone regions 12A, 12B.

The snap-off screw 10 includes a screw body 14 having a screw region 16, and a driver region 18. The screw region 16 is threaded into one or more to the bone regions 12A, 12B, and the driver region 18 is used to rotate the screw region 16 during insertion of the screw region 16. For example, the driver region 18 can be engaged by an insertion tool (not shown) such as a wire driver, a drill, or a screwdriver, to facilitate rotation of the snap-off screw 10 and insertion of the screw region 16 into the one or more bone regions 12A, 12B.

The design and size of each region 16, 18 can vary according to the desired use for the snap-off screw 10.

In FIG. 1, the snap-off screw 10 is illustrated in a decoupled configuration 20 in which the driver region 18 is not coupled, secured, or attached to the screw region 16. With this design, as the screw region 16 is being inserted, the driver region 18 can be decoupled, unattached, cut-off from, broken away from, and/or snapped away from the screw region 16.

As an overview, in certain embodiments, the snap-off screw 10 is designed to break in a unique location so that the screw region 16 does not provide an area of irritation for soft tissue (not shown) around the inserted snap-off screw 10. As a result thereof, the likelihood of success of the procedure is enhanced.

It should be noted that the snap-off screw 10 can be inserted with a pilot hole (not shown) or without a pilot hole, depending upon the condition and type of the one or more bone regions 12A, 12B. In one embodiment, the snap-off screw 10 is self drilling and/or tapping.

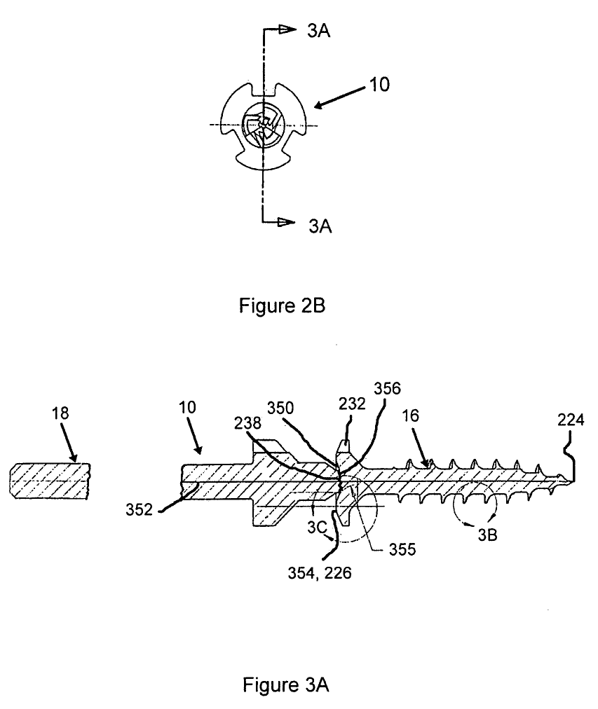

FIG. 2A is a side view of a first embodiment of the snap-off screw 10. The size, shape, and design of the snap-off screw 10 can vary according to the teachings provided herein to meet the design requirements of the snap-off screw 10. In the embodiment illustrated in FIG. 2A, the screw body 14 is generally circular cylinder shaped and has a generally circular shaped cross-section.

In FIG. 2A, the snap-off screw 10 is illustrated in a coupled configuration 222 in which the driver region 18 is coupled, secured, and attached to the screw region 16. With this design, the driver region 18 can be used to insert the screw region 16. It should be noted that a portion of the driver region 18 is not illustrated in FIG. 2A.

In one embodiment, the snap-off screw 10 is integrally formed as a unitary structure. Alternatively, portions of the snap-off screw 10 can separately formed and joined together during manufacturing. The type of material utilized in the screw body 14 can be varied to meet the requirements of the bone regions being fused. For example, the screw body 14 can be formed titanium, stainless steel, or a bio-absorbable material.

The screw region 16 includes a screw distal end 224, an opposed screw proximal end 226, a threaded area 228, a non-threaded area 230, and a head area 232. The screw distal end 224 is the portion of the snap-off screw 10 that is initially inserted into the one or more body regions (not shown in FIG. 2A). The design, shape, and size of the screw region 16 can be varied pursuant to the teachings provided herein. Alternatively, for example, the screw region 16 could be designed without one or more of the areas described above. For example, the screw region 16 could be designed without the non-threaded area 230. In alternative, non-exclusive embodiments, the screw region 16 has a SR length 234 of approximately 10, 11, 12, 13, or 14 millimeters. However, greater or lesser SR lengths 234 can be utilized.

The design and location of the threaded area 228 can vary to suit the insertion requirements for the snap-off screw 10. In FIG. 2A, the threaded area 228 extends from the screw distal end 224 to near the screw proximal end 226. Additionally, in FIG. 2A, the screw distal end 224 and the threaded area 228 are tapered to facilitate self tapping of the threaded area 228 into one or more bone regions. In one non-exclusive embodiment, the screw distal end 224 has a taper of approximately twelve degrees and the threaded area 228 has a taper of approximately ten degrees. Alternatively, the threaded area 228 can have another suitable configuration.

In one embodiment, the threaded area 228 has one or more threads that spiral around the perimeter of the screw region 16. For example, the threaded area 228 can have a thread pitch of approximately 0.4 inches.

In FIG. 2A, the non-threaded area 230 is relatively small and generally cylindrical shaped. In alternative, non-exclusive embodiments, the non-threaded area 230 has a diameter of approximately 0.03, 0.04, 0.05, or 0.06 inches. However, greater or lesser diameters can be utilized.

The head area 230 engages one of the bone regions 12A, 12B, a plate, or another object, and inhibits further insert of the snap-off screw 10. In FIG. 2A, the head area 230 is located at and defines the screw proximal end 226.

The size and shape of the head area 230 can be varied to meet the requirements of the snap-off screw 10. For example, the head area 230 can be shaped somewhat similar to that of a button head screw. In FIG. 2A, the head area 230 is somewhat disk shaped and includes a plurality of spaced apart, circumferentially distributed notches 236. The notches 236 allow for the screw region 16 to be further driven or removed with a driver.

The driver region 18 is designed to be engaged by the insertion tool for insertion of the snap-off screw 10. Further, the driver region 18 can be detached as the screw region 16 is being inserted.

The design of the driver region 18 can be varied to provide the desired area to be engaged by the insertion tool to insert the snap-off screw 10. In FIG. 2A, the driver region 18 is generally cylindrical shaped and includes a driver attachment end fuse 238, an opposed driver distal end 240, and a tool engagement area 242. In alternative, non-exclusive embodiments, the driver region 18 has a DR length 244 of approximately 0.7, 0.8, 0.9, 1, or 1.1 inches. However, greater or lesser DR lengths 244 can be utilized.

The driver attachment end 238 is attached to the screw region 16. In FIG. 2A, the driver region 18 is necked down, e.g. tapered towards the driver attachment end 238. With this design, the driver region 18 is narrowest at the driver attachment end 238. This facilitates breaking and/or decoupling of the driver region 18 from the screw region 16 at the driver attachment end 238.

The driver distal end 240 can be tapered for ease of insertion of the insertion tool over the driver distal end 240.

The tool engagement area 242 is designed to be engaged by the insertion tool. In FIG. 2A, the tool engagement area 242 is generally disk shaped and a plurality of spaced apart, circumferentially distributed slots 246 that facilitate engagement with insertion tool. Alternatively, the tool engagement area 242 can have another configuration. For example, the edges of the slots 246 can be rounded to be more tissue friendly.

FIG. 2B is an end view of the snap-off screw 10.

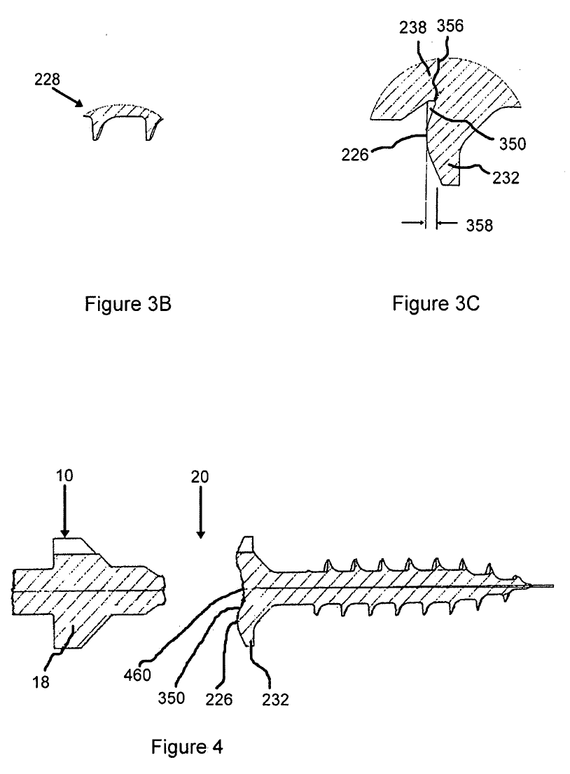

FIG. 3A is a cut-away view taken on line 3A-3A of FIG. 2B. FIG. 3A illustrates that the screw region 16 includes a recessed area 350 that is located near the screw proximal end 226 and the head area 232. In one embodiment, the recessed area 350 is a somewhat annular shaped cutout that is centrally located about a screw central axis 352. The cutout is located in the head area 232 and the driver attachment end 238. Further, in one non-exclusive embodiment, the recessed area 350 has a recessed radius (“head radius”) 355 of approximately 0.4 inches. In one embodiment, the recessed area 350 is substantially encircled by head area 232 and a head top 354 of the head area 232 defines the screw proximal end 226.

As a result of this design, the screw body 14 defines a breakoff area 356 (illustrated as a curved line) that is positioned within the recessed area 350 between the screw distal end 224 and the screw proximal end 226. The breakoff area 356 is the area of the snap-off screw 10 in which the driver region 18 is designed to break off or decouple from the screw region 16. Moreover, in FIG. 3A, the breakoff area 356 is encircled by the head area 232. Further, the driver attachment end 238 is positioned within the recessed area 350 and the driver attachment end 238 is attached to the screw region 16 intermediate the screw distal end 224 and the screw proximal end 226.

FIG. 3B is an enlarged detail view taken from FIG. 3A. FIG. 3B illustrates a portion of the threaded area 228. In one embodiment, the back of the threads are relatively flat. This can give the threaded area 228 enhanced strength against pull out of the threaded area 228.

FIG. 3C is an enlarged detail view taken from FIG. 3A. FIG. 3C illustrates the recessed area 350 and the breakoff area 356 (illustrated as a curved line) in more detail. In this embodiment, the breakoff area 356 and the driver attachment end 238 are positioned approximately a breakoff distance 358 from the screw proximal end 226. In alternative, non-exclusive embodiments, the breakoff distance 358 is at least approximately 0.001, 0.002, 0.005, 0.01, 0.015, 0.02, or 0.025 inches.

Further, the breakoff area 356 and the driver attachment end 238 are recessed below the screw proximal end 226 and the head area 232. Stated in another fashion, the breakoff area 356 and the driver attachment end 238 are encircled by the head area 232.

FIG. 4 is a cut-away view of a portion of the snap-off screw 10 in the decoupled configuration 20. FIG. 4 illustrates that the driver region 18 has broken off from within the recessed area 350. As a result thereof, a screw break surface 460 is positioned away from the screw proximal end 226 and the head area 232, and the screw break surface 460 is recessed below the screw proximal end 226 and a portion of the head area 232. With this design, the screw break surface 460 does not provide an area of irritation for soft tissue (not shown) around the inserted snap-off screw 10. As a result thereof, the likelihood of success of the procedure is enhanced.

While the particular snap-off screw 10 as shown and disclosed herein is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A snap-off screw for screwing into a bone region, the snap-off screw comprising:
a screw body including (i) a screw region having a screw distal end, an opposed screw proximal end, a threaded area, and a head area positioned at the screw proximal end, and (ii) a driver region having a driver attachment end and an opposed driver distal end, the driver attachment end being coupled to the screw region between the screw distal end and the screw proximal end.

2. The snap-off screw of claim 1 wherein the screw region includes a recessed area and the driver attachment end is positioned within the recessed area.

3. The snap-off screw of claim 2 wherein the screw body includes a breakoff area that is positioned within the recessed area, the breakoff area being the area in which the drive shaft region becomes decoupled from the screw region.

4. The snap-off screw of claim 1 wherein breakoff area is encircled by the head area.

5. The snap-off screw of claim 1 wherein the breakoff area is recessed from the head area.

6. The snap-off screw of claim 1 wherein the breakoff area is at least approximately 0.001 inches from the screw proximal end.

7. The snap-off screw of claim 6 wherein the breakoff area is at least approximately 0.01 inches from the screw proximal end.

8. A snap-off screw for screwing into a bone region, the snap-off screw comprising:
a screw body including (i) a screw region having a screw distal end, an opposed screw proximal end, a threaded area positioned near the screw distal end, a head area positioned at the screw proximal end, and a recessed area that is positioned at the screw proximal end, and (ii) a driver region having a driver attachment end and an opposed driver distal end, the driver attachment end being coupled to the screw region within the recessed area.

9. The snap-off screw of claim 8 wherein the screw body includes a breakoff area that is positioned within the recessed area, the breakoff area being the area in which the drive shaft region becomes decoupled from the screw region.

10. The snap-off screw of claim 9 wherein breakoff area is encircled by the head area.

11. The snap-off screw of claim 8 wherein the breakoff area is recessed from the head area.

12. The snap-off screw of claim 8 wherein the breakoff area is at least approximately 0.001 inches from the screw proximal end.

13. The snap-off screw of claim 12 wherein the breakoff area is at least approximately 0.01 inches from the screw proximal end.

14. A method of engaging a bone region, the method comprising the steps of:
threading a screw region of a snap-off screw into a bone region, the screw region including a screw distal end, an opposed screw proximal end, a threaded area, and a head area positioned at the screw proximal end, and
decoupling a driver region of the snap-off screw from the screw region so that a screw break surface of the screw region is recessed below at least a portion of the head area.

15. The method of claim 14 wherein the screw region includes a recessed area and wherein the step of decoupling includes the step of the screw break surface being positioned within the recessed area.

16. The method of claim 15 wherein the screw body includes a breakoff area that is positioned within the recessed area, the breakoff area being the area in which the drive shaft region becomes decoupled from the screw region.

17. The method of claim 16 wherein breakoff area is encircled by the head area.

18. The method of claim 16 wherein the breakoff area is recessed from the head area.

19. The method of claim 16 wherein the break-off area is at least approximately 0.001 inches from the screw proximal end.
